(19) United States
(12) Patent Application Publication
(10) Pub. No.: US 2005/0283778 A1
(43) Pub. Date: Dec. 22, 2005

(54) System and method for identifying installation modes for device drivers

(75) Inventor: Michael J. Barton, Apex, NC (US)

Correspondence Address: SAWYER LAW GROUP LLP, PO BOX 51418, PALO ALTO, CA, 94303, US

(73) Assignee: International Business Machines Corporation, Armonk, NY (US)

(21) Appl. No.: 10/872,295

(22) Filed: Jun. 17, 2004

(51) Int. Cl. G06F 9/445

(52) U.S. Cl. 717/174

(57) ABSTRACT

A method and system for establishing an installation mode for a device driver is disclosed. The method and system comprises a scanning each file of the device driver, and assigning points to each file according to patterns detected. The method and system includes delivering the installation mode based on the points. Accordingly, a system and method in accordance with the present invention analyzes the device files for a driver and assigns points to various parameters of the files determining which installation mode is appropriate. In so doing, a customer can easily and correctly install a driver in a particular operating system.

### FIELD OF THE INVENTION

The present invention relates generally to processing systems and more particularly to installing device drivers in operating systems for such processing systems.

### BACKGROUND OF THE INVENTION

Handling installation for device drivers such as Microsoft Device Drivers for Windows Server 2000 and 2003 is both time consuming and cumbersome. For example, the installation mode for every driver used for deploying Microsoft Operating Systems must be identified and depending on the installation mode of the driver, the driver information must be entered into the Microsoft Installation answer file.

It has been a challenge for every company trying to perform unattended installations of the Microsoft Operating Systems to properly install device drivers. All too often customers call in asking which lines they should put into the Microsoft unattended installation answer file. Accordingly, what is needed is a system and method for allowing customers to easily identify the installation mode for a device driver in a particular operating system. The system and method should be easy to install, cost effective and easily implemented with existing operating systems. The present invention addresses such a need.

### SUMMARY OF THE INVENTION

A method and system for establishing an installation mode for a device driver is disclosed. The method and system comprises scanning each file of the device driver, and assigning points to each file according to patterns detected. The method and system includes delivering the installation mode based on the points. Accordingly, a system and method in accordance with the present invention analyzes the device files for a driver and assigns points to various parameters of the files determining which installation mode is appropriate. In so doing, a customer can easily and correctly install a driver in a particular operating system.

### BRIEF DESCRIPTION OF THE DRAWINGS

FIG. 1 illustrates a hardware environment used to implement the present invention.

FIG. 2 is a simple flow chart of a method in accordance with the present invention.

FIGS. 3-9 are flow charts for identifying the installation mode of a device driver in a Windows operating system environment in accordance with the present invention.

### DETAILED DESCRIPTION

The present invention relates generally to processing systems and more particularly to installing device drivers in operating systems for such processing systems. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

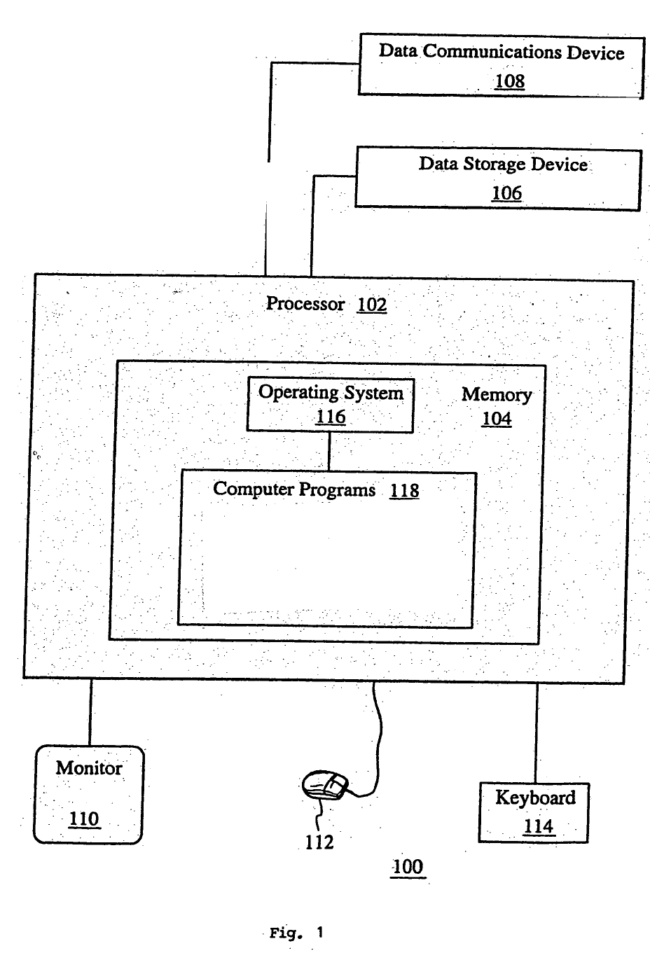

FIG. 1 illustrates a hardware environment used to implement the present invention. As illustrated in FIG. 1, in the preferred embodiment the present invention is implemented in a computer 100. The computer 100 generally includes, a processor 102, a memory 104 such as a random access memory (RAM), a data storage device 106 (e.g., hard drive, floppy disk drive, CD-ROM disk drive, etc.), a data communication device 108 (e.g., modem, network interface device, etc.), a monitor 110 (e.g., CRT, LCD display, etc.), a pointing device 112 (e.g., a mouse, a track ball, a pad or any other device responsive to touch, etc.) and a keyboard 114. It is envisioned that attached to the computer 100 may be other devices such as read only memory (ROM), a video card drive, printers, peripheral devices including local and wide area network interface devices, etc. One of ordinary skill in the art will recognize that any combination of the above system components may be used to configure the computer 100.

The computer 100 operates under the control of an operating system (“OS”) 116, such as Windows 2000, Windows 2003, Windows 2000 Professional and Windows XP, etc., which typically, is loaded into the memory 104 during the computer 100 start-up (boot-up) sequence after power-on or reset. In operation, the OS 116 controls the execution by the computer 100 of computer programs 118, including server and/or client-server programs.

Alternatively, a system and method in accordance with the present invention may be implemented with any one or all of the computer programs 118 embedded in the OS 116 itself without departing from the scope of the invention. Preferably, however, the client programs are separate from the server programs and are not resident on the server.

The OS 116 and the computer programs 118 each comprise computer readable instructions which, in general, are tangibly embodied in or are readable from a media such as the memory 104, the data storage device 106 and/or the data communications device 108. When executed by the computer 100, the instructions cause the computer 100 to perform the steps necessary to implement the present invention. Thus, the present invention may be implemented as a method, apparatus, or an article of manufacture (a computer-readable media or device) using programming and/or engineering techniques to produce software, hardware, firmware, or any combination thereof.

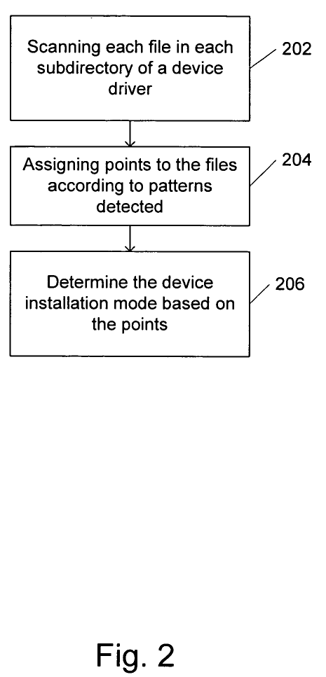

A method and system in accordance with the present invention has the capability of scanning one or more drivers and automatically determining the correct installation mode for the driver(s) and which file is the main driver installation file. FIG. 2 is a simple flow chart of a method in accordance with the present invention. Referring to FIG. 2, this system scans each file in each subdirectory of a device driver, via step 202, and then points are assigned to the files according to different patterns detected, via step 204. The file with the most points is the main installation file and the device driver installation mode is then determined based upon the points via step 206.

To describe the present invention in the context of a specific example, refer now to the following description in conjunction with the accompanying figures. The present invention is described in the context of a Windows operating system environment, in which there are three installation modes. In a preferred embodiment, the valid installation modes are Textmode, Plug-n-Play, or Executable.

One of ordinary skill in the art readily recognizes that the present invention could be utilized in any operating system that incorporates device drivers. Furthermore, although the three installation modes are described herewith, any number of installation modes could be supported and their use would be within the spirit and scope of the present invention.

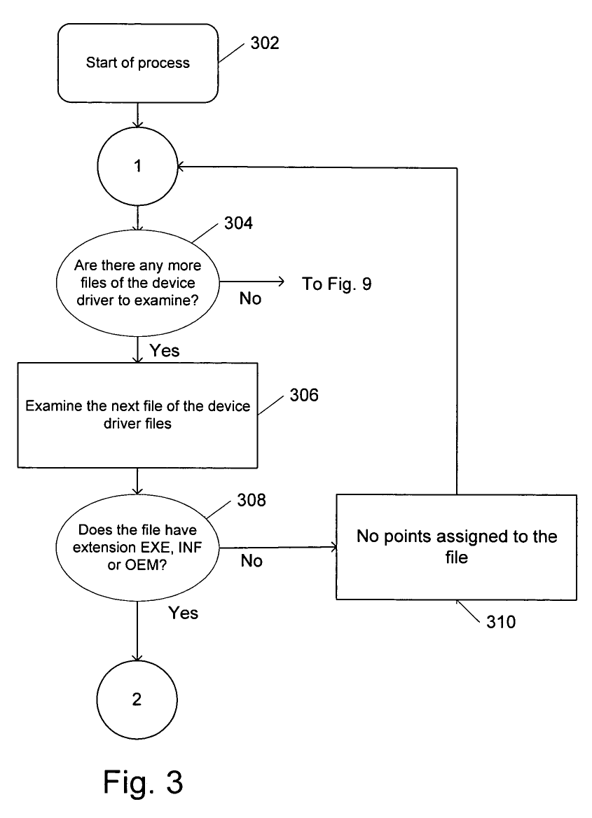

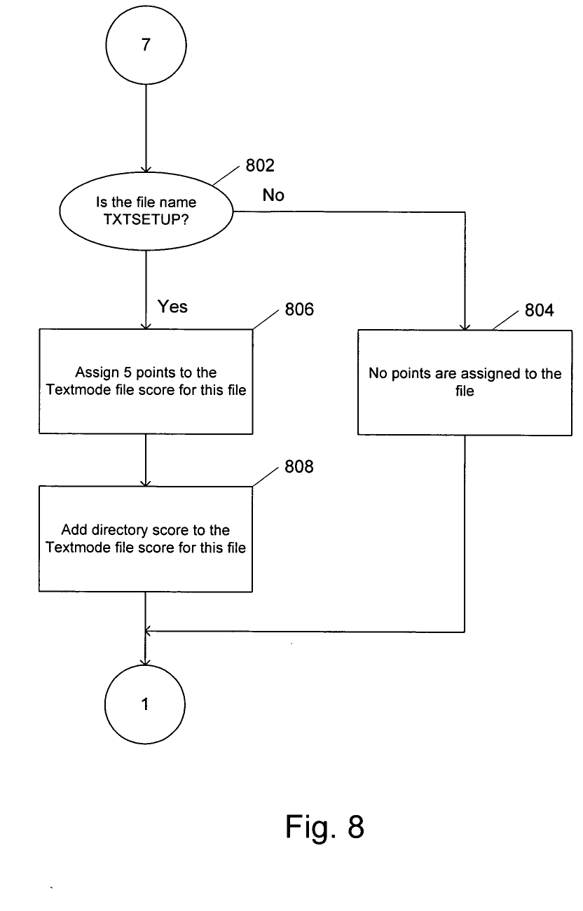

FIGS. 3-9 are flow charts for installing device drivers in a Windows operating system environment in accordance with the present invention. Referring now to FIG. 3, when installing a Windows device driver files, first a diskette or other media will be provided to computer to analyze the driver files thereon. The other media includes, but is not limited to, a CD, or a zip file download from a website. As is seen in FIG. 3, first the process is started, via steps 302. Next, it is determined if there are any more device driver files to examine, via step 304. If the answer is no, then the device driver file with the most points will be determined at that point. This will be discussed in detail hereinafter. However, if there are more device driver files to be examined, the next file in the device driver file is examined, via step 306. Then it is determined if the file has one of the three extensions, EXE, INF or OEM, via step 308. If the answer is no, then return to determining if there are any more device driver files to examine, via step 304. However, if the answer is yes, then the next step is to calculate the DirectoryScore for the file.

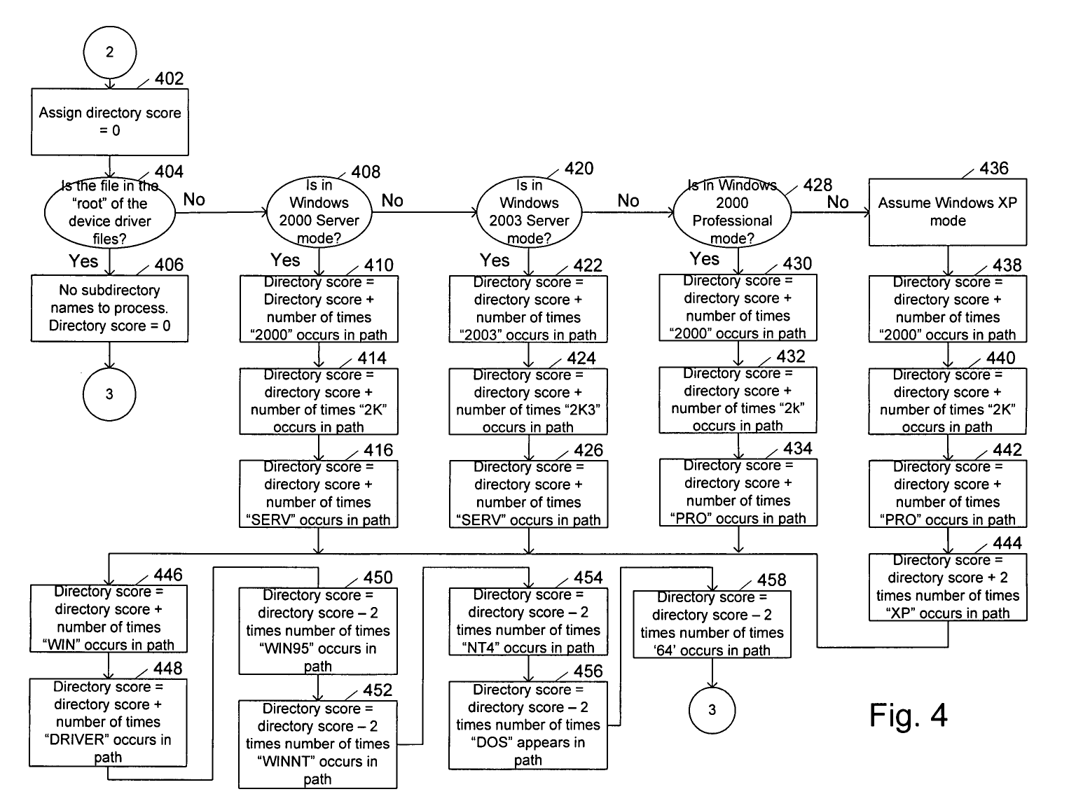

FIG. 4 illustrates calculating the DirectoryScore for the file. First a DirectoryScore of 0 is assigned, via step 402. Then it is determined if the file is in the root of the device driver file, via step 404. If the answer is yes, then there are no subdirectory names to process, and the DirectoryScore remains 0. If the answer is no, via step 404, then it is determined whether the method and system (the program using the algorithm, in this case the program is called DScan.exe, the Device Driver Scan Tool) is in a Windows 2000 Server mode, via step 408. If the answer is yes, then the new DirectoryScore equals the DirectoryScore plus the number of times the number “2000” occurred in the path, via step 410. The DirectoryScore equals the DirectoryScore plus the number of times “2K’ occurs in the path, via step 412. The DirectoryScore equals the DirectoryScore plus the number of times “SERV” occurs in the path.

If, on the other hand, if the method and system (or program) is not in Windows 2000 Server mode 408, it is then determined whether the method and system (or program) is in Windows 2003 Server mode, via step 418. Similarly, if the answer is yes, the DirectoryScore equals the DirectoryScore plus the number of times “2003” occurs in the path, via step 420, plus the score plus the number of times “2K3” occurs in the path, via step 424, and the DirectoryScore equals the DirectoryScore plus the number of times “SERV” occurs in the path via step 426.

If the method and system (or program) is not in the Windows 2003 Server mode via step 420, it is determined whether the method and system (or program) is in the Windows 2000 Professional mode, via step 428. If the answer is yes, then the DirectoryScore equals the DirectoryScore plus the number of times “2000” occurs in the path, via step 430, plus the DirectoryScore equals the DirectoryScore plus the number of times “2K’ occurs in the path, via step 432, plus the number of times “PRO” occurs in the path via step 434.

Finally, if the method and system (or program) is not in the Windows 2000 Professional mode operating system, then it must be assumed that the method and system (or program) is in the Windows XP mode, via step 436. First, the DirectoryScore of the file equals the DirectoryScore plus the number of times the number “2000” occurs in the path, via step 438, plus the number of times “2K’ occurs in the path, plus the number of times “PRO” occurs in the path, and finally plus 2 times the number of times “XP occurs in the path, via step 444.

At this point, depending on whichever server mode the method and system (or program) is in, the DirectoryScore is further calculated by first adding the DirectoryScore plus the number of times “WIN” occurs in the path, via step 446. Then the DirectoryScore equals the DirectoryScore plus the number of times “driver” occurs in the path, via step 448. Then that number of the DirectoryScore is minus 2 times the number of times “WIN95” occurs in the past, via step 450, minus 2 times the number of times “WINNT” occurs in the path, via step 452 minus 2 times the number of times “NT4” occurs in the path, via step 454 minus 2 times the number of times “DOS” occurs in the path, via step 456, and the minus 2 times the number of times “64” occurs in the path, via step 458. This score provides the total DirectoryScore for the file.

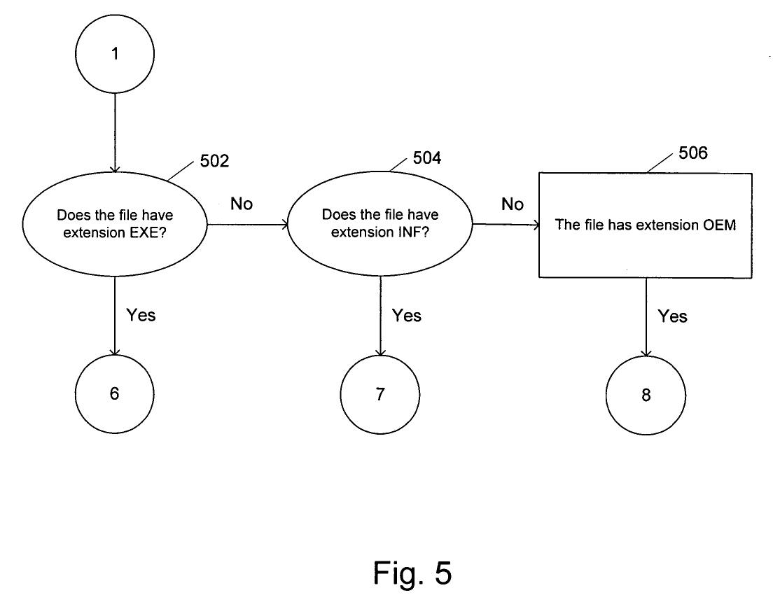

FIG. 5 illustrates determines what the next step is to determine what is a FileScore for the file. The first thing that must be determined is “what kind of file is it?” It is first determined what kind of file is being used. If the file has the extension EXE, via step 502. If the answer is yes, then the EXE file flow will be determined. If the answer is no, then it is determined does the file have the extension INF, via step 504 indicating a PNP file. If it does, then the INF files will be determined. Finally, if the file does not have the extension of either EXE or INF, then the file has to have the extension OEM, via step 506, and then the Textmode files can be determined.

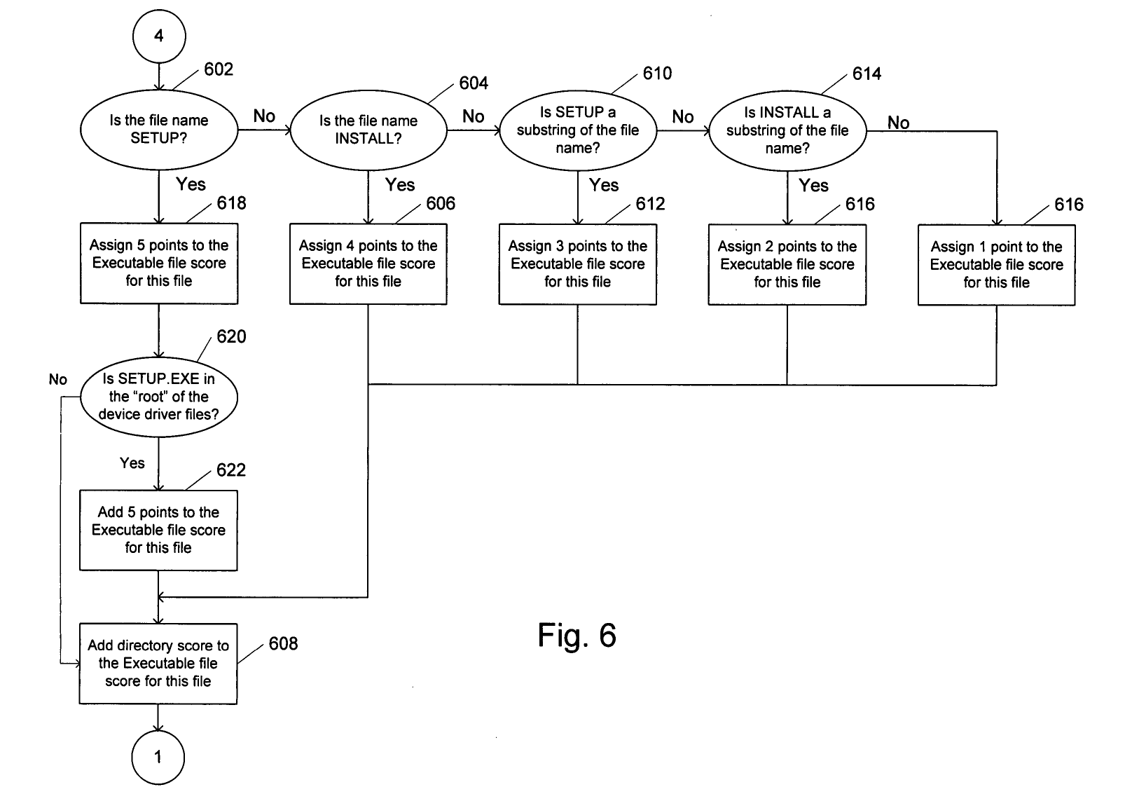

Next, the FileScore for the appropriate file is calculated. FIGS. 6, 7 and 8 are flow charts which illustrate calculating the FileScore for each of the Executable, PNP and Textmode files, respectively.

Referring now to FIG. 6, once it is determined that it is an executable file, first it is determined if the file is named “SETUP”, via step 602. If the answer is no, then it is determined if the file name is “INSTALL”, via step 604. If the file name is “install,” then 4 points are assigned to the Executable FileScore for this file and you add the DirectoryScore to the executable FileScore for this file via steps 606 and 608. If the answer to step 604 is no, then it is determined whether “SETUP” is a substring of the file name, via step 610. If it is a substring, then 3 points are assigned to the Executable FileScore, via step 612, and add the DirectoryScore to this Executable FileScore, via step 608. If the answer to step 610 is no, then it is determined whether “install” is a substring of the file name, via step 614. If it is a substring of the file name, then 2 points are assigned to the executable FileScore for this file, via step 616, and add the DirectoryScore to this Executable FileScore, via step 608. If the answer to step 614 is no, then 1 point is assigned to the Executable FileScore, via step 616 and add the DirectoryScore to this Executable FileScore, via step 608.

Referring back to step 602, if it is determined that the file name is “SETUP”, then 5 points are assigned to the Executable FileScore, via step 618. Next it is determined whether “setup.exe” is in the root of the device driver file. If it is not, then the DirectoryScore is added to the Executable FileScore, via step 608. If, on the other hand, “setup.exe” is in the root of the device driver file, via step 620, then 5 points is added to the Executable FileScore for this file, via step 622, and then add the DirectoryScore to the Executable FileScore, via step 608. Once the Executable FileScore for this file is determined, then return to step 304 of FIG. 3.

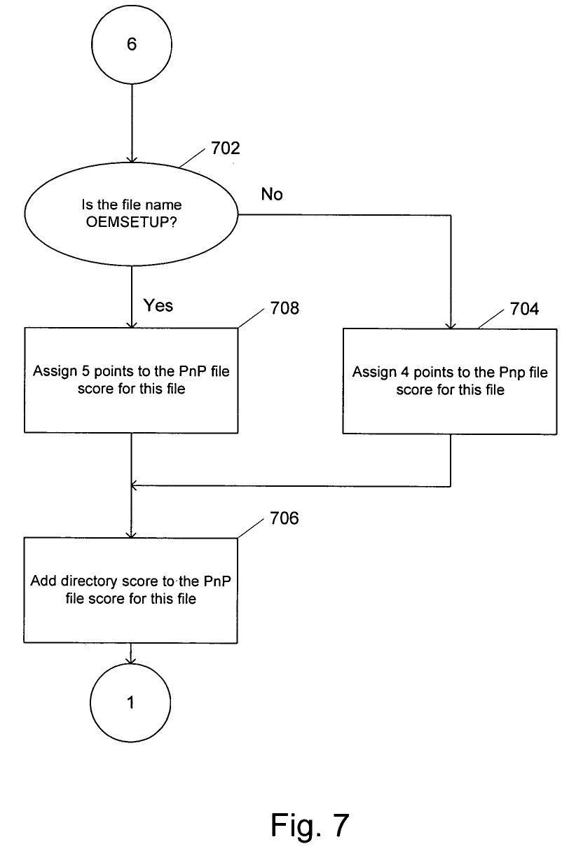

FIG. 7 illustrates calculating the plug and play (PnP) FileScore for the file. It is first determined, is the file name “oemsetup”, via step 702. If the answer is no, 4 points are assigned to the PnP file, via step 704 and add the DirectoryScore to the PnP FileScore for this file, via step 706. If the answer to step 702 is yes, 5 points are assigned to the PnP FileScore for this file, via step 708. Then add the DirectoryScore to the PnP FileScore for the total PnP FileScore for the file, via step 706. Once again, upon calculating the total PnP FileScore, then return to step 304 in FIG. 3.

Finally, calculate the Textmode FileScore for the file. First, it is determined is the file named “txtsetup”, via step 802. If the answer is no, no points are assigned to the file, via step 804. If the answer to step 802 is yes, 5 points are assigned to the Textmode FileScore for this file, and add the DirectoryScore to the Textmode FileScore for this file, via step 808. Then, as before mentioned, return to step 304 in FIG. 3.

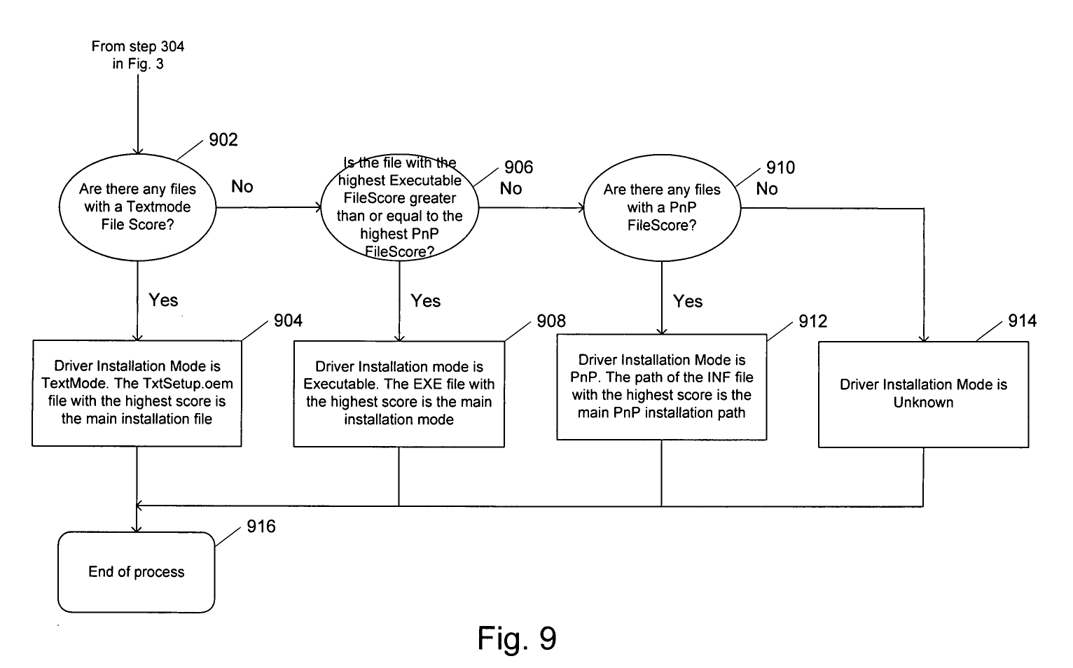

Once it is determined that all the files have been examined via step 304, then the appropriate installation mode can then be determined. FIG. 9 illustrates the final determination of the appropriate installation mode. Accordingly, first it is determined if there are any files with a Textmode FileScore, via step 902. If the answer is yes, the driver installation mode is Textmode. The Txtsetup.oem file with the highest score is the main installation file, via step 904 and the process is ended via step 916. If, however, it is determined that there are no files with a Textmode FileScore, then it is determined if the file with the highest Executable FileScore is greater than or equal to the highest PnP FileScore, via step 906. If the answer is yes, the driver installation mode is Executable, via step 908. The EXE file with the highest score is the main installation file, and he process is ended via step 916.

However, if the answer to step 906 is no, then it is determined if there are any files with a PnP FileScore, via step 910. If there are, then the driver installation mode is PnP, and the path of the INF file with the highest score is the main PnP installation path, via step 912, and then the process ends, via step 916. Finally, if the answer to step 910 is no, the driver installation mode is unknown, via step 914, and the process ends, via step 916.

Accordingly, a system and method in accordance with the present invention analyzing the files for a device driver and assigns points to various parameters of the files determining which installation mode is appropriate. In so doing, a customer can easily and correctly install a driver in a particular operating system.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for identifying an installation mode for a device driver comprising:
scanning each file of the device driver;
assigning points to each file according to patterns detected; and
providing the installation mode based on the points.

2. The method of claim 1 wherein the installation mode comprises any of Textmode, Plug and Play or Executable.

3. The method of claim 1 wherein the points are assigned based upon the sum of a DirectoryScore and a FileScore for each file.

4. The method of claim 1 wherein each file of the device driver is on a diskette.

5. The method of claim 1 wherein each file of the device driver is on a C.D.

6. The method of claim 1 wherein each file of the device driver is downloaded from a website.

7. The method of claim 1 wherein assigning points comprises:
calculating a DirectoryScore;
calculating a FileScore; and
adding the calculated DirectoryScore to the calculated FileScore to provide a total FileScore.

8. The method of claim 7 wherein the determining step comprises determining the device installation mode based on the total FileScore.

9. A computer readable medium containing program instructions for identifying an installation mode for a device driver, the program instructions for:
scanning each file of the device driver;
assigning points to each file according to patterns detected; and
providing the installation mode based on the points.

10. The computer readable medium of claim 9 wherein the installation mode comprises any of Textmode, Plug and Play or Executable.

11. The computer readable medium of claim 9 wherein the points are assigned based upon the sum of a DirectoryScore and a FileScore.

12. The computer readable medium of claim 9 wherein each file of the device driver is on a diskette.

13. The computer readable medium of claim 9 wherein each file of the device driver is on a CD.

14. The computer readable medium of claim 9 wherein each file of the device driver is on downloaded from a website.

15. The computer readable medium of claim 9 wherein assigning points comprises:
calculating a DirectoryScore;
calculating a FileScore; and
adding the calculated DirectoryScore to the calculated FileScore to provide a total FileScore.

16. The computer readable medium of claim 15 wherein the determining step comprises determining the device installation mode based on the total FileScore.

17. A processor comprising:
an operating system; and
a computer program responsive to the operating system for identifying an installation mode for a device driver.

18. The processor of claim 17 wherein computer program scans each file of the device driver, assigns points to each file according to patterns detected and determines the installation mode based on the points.

19. The processor of claim 17 wherein the installation mode comprises any of Textmode, Plug and Play or Executable.

20. The processor of claim 17 wherein the points are assigned based upon the sum of a DirectoryScore and a FileScore.

21. The processor of claim 17 wherein each file of the device driver is on a diskette.

22. The processor of claim 17 wherein each file of the device driver is on a CD.

23. The processor of claim 17 wherein each file is downloaded from a website.

24. The processor of claim 17 wherein assigning points comprises:
calculating a DirectoryScore;
calculating a FileScore; and
adding the calculated DirectoryScore to the calculated FileScore to provide a total FileScore.

25. The processor of claim 24 wherein the determining step comprises determining the device installation mode based on the total FileScore.
